(19) United States
(12) Patent Application Publication
(10) Pub. No.: US 2025/0197021 A1
(43) Pub. Date: Jun. 19, 2025

(54) VERTICAL TAKE-OFF AND LANDING AIRCRAFT USING A HYBRID PROPULSION SYSTEM AND ITS CONTROL METHOD

(71) Applicant: CHANGINAVIATION CO., LTD., Incheon (KR)

(72) Inventors: Chang Mo MOON, Seoul (KR); Ji Ho MOON, Seoul (KR)

(21) Appl. No.: 18/849,400

(22) PCT Filed: Nov. 29, 2022
(86) PCT No.: PCT/KR2022/019011

§ 371 Date: Sep. 20, 2024

(30) Foreign Application Priority Data
Jan. 4, 2022 (KR) 10-2022-0001062

(51) Int. Cl. B64D 31/18; B64C 29/00; B64D 35/022

(52) U.S. Cl. CPC B64D 31/18; B64C 29/0025; B64D 35/022; B64D 2221/00

(57) ABSTRACT

Provided are a vertical takeoff and landing aircraft using a hybrid propulsion system and a control method therefor, the aircraft including: a thrust propeller for generating thrust in an aerial vehicle; a lift propeller for generating lift in the aerial vehicle; an engine which is installed in the aerial vehicle and burns fuel to produce power; a clutch device for transmitting the power of the engine to the thrust propeller; a first power generator that generates electrical power by means of the rotational force of the thrust propeller when the thrust propeller rotates as the aerial vehicle descends or flies into a headwind; a second power generator that generates electrical power by means of the rotational force of the lift propeller when the lift propeller rotates as the aerial vehicle descends or flies into a headwind; a battery management system in which the electricity generated from the first and second power generators is charged; and a control unit that controls the first and second power generators to operate as motors when the aerial vehicle ascends or flies with a tailwind.

### FIELD OF INVENTION

The present invention relates to a vertical take-off and landing aircraft using a hybrid propulsion system.

### BACKGROUND OF INVENTION

Vertical take-off and landing aircraft based on rotor blades, such as helicopters, have the advantage of not requiring separate take-off and landing facilities or equipment, but have lower performance than fixed-wing aircraft of the same class in high-speed flight, long endurance and high-altitude performance.

A lift & cruise type flight vehicle is adopted in which vertical take-off and landing is performed like a helicopter, while transition flight and cruise flight are performed in the form of a fixed wing.

Further, in order to improve weight efficiency, the aircraft uses a lithium polymer battery and an electric motor with high instantaneous maximum output efficiency during takeoff and landing, and also utilizes a reciprocating engine using fossil fuel or a turbo-shaft engine with high energy density during transition flight and cruise flight.

On the other hand, conventional flight vehicles urgently need development of technologies to propose solutions that: develop stable transition flight technology; solve noise problems in urban areas; reduce air resistance to maximize energy efficiency; remove accident factors that may occur at the moment of transition flight and vertical take-off and landing so as to safely land vertically when an emergency situation arises.

### PRIOR ART LITERATURE

### Patent Literature

(Patent Document 1) KR 10-2011-0112402 A
(Patent Document 2) KR 10-1667330 B1
(Patent Document 3) KR 10-1615486 B1
(Patent Document 4) KR 10-1638964 B1
(Patent Document 5) KR 10-2004227 B1
(Patent Document 6) KR 10-2279741 B1

### SUMMARY OF INVENTION

### Technical Problem to be Solved

Therefore, a technical object to be achieved by the present invention is to provide a vertical take-off and landing aircraft using a hybrid propulsion system that allows first and second generators to generate power when the aircraft is in the headwind or descends, so as to charge the battery pack and thereby increase the flight time, as well as a control method thereof.

Further, another object of the present invention is to provide a vertical take-off and landing aircraft using a hybrid propulsion system that can efficiently use available energy by resolving a large difference in thrust between vertical take-off and landing and cruise flight, as well as a control method thereof.

Another object of the present invention is to provide a method for improving safety while supplementing the weaknesses of conventionally known vertical take-off and landing aircraft.

Another object of the present invention is to add a generator function and a boosting electric motor function to an electric motor for starting when a reciprocating engine or a turbo shaft engine using fossil fuel is adopted, and to allow the engine to properly transmit and cut off power to a clutch so as to enable the above functions, whereby various operating options can be efficiently selected and utilized in consideration of characteristics of a lithium polymer battery that can have high energy density engine output and instantaneous maximum output.

Another object of the present invention is to make a fossil fuel engine causing noise to perform idling, to stop or to be restarted during flight as necessary, and thus to satisfy the noise level required in a residential or commercial area.

Another object of the present invention is to improve weight efficiency and energy efficiency so that the propeller for vertical takeoff and landing, which is exposed to the outside during cruising and becomes a factor that increases air resistance, not only reduces air resistance but also descends at a headwind, may be used as a propeller for wind power generation whereby the electric motor for take-off and landing can also become a generator in combined use. Further, controlling it to ascend with minimum energy and generating power while repeating descent and ascent flight may enable the battery to be charged so that the flight time or flight distance can be increased.

Another object of the present invention is to provide a propeller for vertical take-off and landing that is fixed without tilting during vertical take-off and landing and transition flight, and independently has a responding ability to wind gusts in the front and rear directions during vertical take-off and landing. Further, in order to increase a response speed to the control, the propeller for forward propulsion may generate thrust by an electric motor independently of the power of the engine.

Further, another object of the present invention is to additionally mount a flap as a high-lift device, and a winglet capable of reducing induced drag, to the improved control and mechanical device, and to thus improve a control system that uses a short-distance landing way and vertical landing in sequential order, resulting in safe emergency landing when emergency landing is required due to engine failure, thereby eliminating the cause of accident in advance while securing the emergency landing capability.

As understood from the above background, the vertical take-off and landing aircraft using a hybrid propulsion system and the control method thereof according to the embodiments of the present invention avoid a tilt rotor method to thus fundamentally exclude a mechanical structure for adjusting a vertical angle. As a result, the weight of the aircraft is reduced while increasing a flying range.

Further, the vertical take-off and landing aircraft using a hybrid propulsion system and the control method thereof according to the embodiments of the present invention exclude a vertical angle adjustment process of a driving source to thus realize stable vertical take-off and landing and cruise flight.

Further, flaps and winglets are mounted on the main wing such that, when normal flight is difficult due to engine failure and an emergency landing is required, the aircraft glides to an open area where the emergency landing is possible at the closest distance to avoid a collision with a ground geographic feature with the remaining battery capacity, approaches the open area in a short take-off and landing (STOL) mode, and then can flight in a vertical take-off and landing (VTOL) mode at altitudes where ground effects are expressed; power transmission is blocked using an electronically controllable clutch so that the failed engine does not act as a brake; and the hybrid engine mode has been improved to be operated only electrically.

### Technical Solution

A vertical take-off and landing aircraft using a hybrid propulsion system according to an embodiment of the present invention in order to achieve the above technical objects mat include: a thrust propeller 81 generating thrust to a flight vehicle (that is, aircraft) 1; a lift propeller 82 generating lift force to the aircraft 1; an engine 10 installed on the aircraft 1 and generating power by burning of fuel; a clutch device 16 for transmitting power of the engine 10 to the thrust propeller 81; a first generator 20 that rotates the thrust propeller 81 when the aircraft 1 descends or flies against the headwind, and generates electric power with rotational force of the thrust propeller 81; a second generator 80 that generates electric power by rotational force of the lift propeller 82 if the lift propeller 82 rotates when the aircraft 1 descends or flies against the headwind; a battery management system 60 for stably charging the battery with the electricity generated from the first and second generators 20 and 80; a battery pack 62 composed of a lithium polymer battery that has an emergency battery package in parallel, a charging rate of at least 2 C-Rate or more, and a discharging rate of up to 60 C-Rate; and a control unit 90 that controls the first and second generators 20 and 80 to work as electric motors when the aircraft 1 flies upward or flies with a tailwind.

Further, with regard to the vertical take-off and landing aircraft using a hybrid propulsion system according to an embodiment of the present invention, the control unit 90 may control the clutch device 16 to cut off power in order to prevent bi-directional power transmission between the engine 10 and the first generator 20 when utilizing the first generator as an electric motor in order to stop the engine or operate the engine only electrically in an idling state to reduce unexpected engine failure or noise on purpose, or when operating the first generator 20 as a generator using the power of wind.

Further, with regard to the vertical take-off and landing aircraft using a hybrid propulsion system according to an embodiment of the present invention, the control unit 90 may control an angle of attack to be reduced such that the thrust of the thrust propeller 81 never affects flight of the aircraft 1 when the aircraft 1 vertically takes off and lands.

Further, with regard to the vertical take-off and landing aircraft using a hybrid propulsion system according to an embodiment of the present invention, the control unit 90 may increase the thrust of the thrust propeller 81 when the aircraft 1 is in cruise flight or transition flight, and may also control the battery pack 62 of the battery management system 60 to be charged with surplus electric power generated by the first generator 20.

Further, with regard to the vertical take-off and landing aircraft using a hybrid propulsion system according to an embodiment of the present invention, the battery pack 62 may be configured such that emergency batteries are arranged in parallel, and may have a charging rate faster than 2C-Rate and a discharging rate faster than the maximum 60 C-Rate when managed by the battery management system 60.

Further, with regard to the vertical take-off and landing aircraft using a hybrid propulsion system according to an embodiment of the present invention, the first generator 20 may work as a motor to increase thrust within the limit of allowable inertia moment of the clutch 16 in addition to the output of the engine 10, otherwise, may work as a separate motor independent of the engine 10.

Further, the vertical take-off and landing aircraft using a hybrid propulsion system according to an embodiment of the present invention may further include a first power management unit 30 to manage electric power by receiving a command from the control unit 90, wherein the first management unit 30 manages the electric power produced by the first generator 20, distributes the electric power to electronic components requiring electric power, and monitors whether excess electric power is produced and, when the excess electric power is produced, controls the output of the engine 10 to decrease through the control unit 90 and an engine controller.

A method for controlling a vertical take-off and landing aircraft using a hybrid propulsion system according to an embodiment of the present invention may include: a first step (S1) of operating a thrust propeller 81 using power from an engine 10 or electricity from a battery pack 62 and operating a lift propeller 82 using the electricity from the battery pack 62 to fly the aircraft; a second step (S2) of operating the first generator 20 with rotational force of the thrust propeller 81 to generate electric power while operating a second generator 80 with rotational force of the lift propeller 82 to generate electric power when the aircraft 1 is flying in a headwind or descends; a third step (S3) of charging the battery pack 62 with the electric power generated by the first and second generators 20 and 80 in the above second step (S2); a fourth step (S4) of operating the thrust propeller 81 using the power of the engine 10 or the electricity of the battery pack 62 while operating the lift propeller 82 with the electricity of the battery pack 62 when the aircraft 1 meets tailwind or ascends.

Further, with regard to the control method of a vertical take-off and landing aircraft using a hybrid propulsion system according to an embodiment of the present invention, the clutch may be powered off in the second step (S2) to prevent power transmission from the engine 10 to the thrust propeller 81.

Further, with regard to the control method of a vertical take-off and landing aircraft using a hybrid propulsion system according to an embodiment of the present invention, an angle of attack may be controlled to be reduced such that the thrust of the thrust propeller 81 does not influence on the flight of the aircraft 1 when the aircraft 1 takes off and lands vertically.

Further, with regard to the control method of a vertical take-off and landing aircraft using a hybrid propulsion system according to an embodiment of the present invention, the thrust of the thrust propeller 81 may be increased when the aircraft 1 is in cruise flight or transition flight, while the surplus electric power generated in the first generator 20 may be charged in the battery pack 62 of the battery management system 60.

Further, with regard to the vertical take-off and landing aircraft using a hybrid propulsion system according to an embodiment of the present invention, when an emergency landing is required due to difficulties in normal flight caused by an unexpected engine failure, the control unit 90 may perform the controlling such that: the aircraft is optimized and operated in a pure electric manner using the remaining battery capacity in the hybrid mode and glides to an open area where emergency landing is possible at the closest distance to avoid collision with ground geographic features; since high-lift flaps and winglets to reduce induced drag are mounted on the main wings, the aircraft may approach in a short take-off and landing (STOL) mode; and, when the aircraft enters the ground effect altitude, an electronic clutch device 16 is used to block power transmission to thus prevent the failured engine from playing a role of brake, thereby making it possible to perform a vertical take-off and landing (VTOL) mode.

Details of other embodiments are included in the detailed description of invention and the accompanying drawings.

### Effect of Invention

The vertical take-off and landing aircraft using a hybrid propulsion system and its control method according to the embodiments of the present invention, as described above, when the aircraft meets a headwind or descends, the first and second generators produce electric power to charge the battery pack, thereby achieving effects of increasing flight time.

Further, with regard to the vertical take-off and landing aircraft using a hybrid propulsion system and its control method according to an embodiment of the present invention, even if the power generated by the engine is transmitted to the second propeller during vertical take-off and landing, a feathering state is maintained to reduce power loss. Further, adjusting an angle of attack of the second propeller at the transition flight altitude when the aircraft is in transition flight, may regulate desired thrust. In addition, adjusting the angle of attack of the second propeller may also produce desired thrust when the aircraft is in cruise flight.

The ‘feathering state’ used in the present invention refers to a case in which thrust is not generated because blades of the propeller are almost parallel to the ground surface in the traveling direction of the aircraft or almost perpendicular to the ground surface thus not generating thrust.

Further, with regard to the vertical take-off and landing aircraft using a hybrid propulsion system and a control method thereof according to an embodiment of the present invention, a clutch device capable of electronically controlled may further be included, so that power transmission from the engine to the second propeller during vertical take-off and landing is cut off to thus reduce power loss; during the transition flight, power is transmitted to the second propeller by the clutch device at the transition flight altitude while controlling the engine controller to regulate the engine output; and, during cruise flight, power is transmitted to the second propeller by the clutch device while the first propeller for vertical take-off and vertical landing may be matched with the aircraft's traveling direction to thus efficiently distribute and use energy.

Meanwhile, the vertical take-off and landing aircraft using a hybrid propulsion system and a control method thereof according to an embodiment of the present invention may use the first propeller when vertically ascending or descending for take-off and landing. When the second propeller adjusts the angle of attack and rotates in the feathering state so as to be controlled not to generate thrust, electricity output from the engine, the generator and the power management unit are simultaneously used for the operation of the first propeller and charging/discharging at a high C-Rate is possible so that battery capacity may be reduced thereby decreasing the weight of the battery, and the weight of the aircraft may also be reduced by the reduction of the battery.

Further, with regard to the vertical take-off and landing aircraft using a hybrid propulsion system and a control method thereof according to an embodiment of the present invention, a tilt rotor mode is avoided to thus fundamentally exclude a mechanical structure for adjusting the vertical angle, thereby reducing the weight of the aircraft while increasing the flight range. Further, by excluding a process of adjusting the vertical angle of the driving source, stable vertical take-off and landing and cruise flight can be implemented. Specifically, the mechanical mechanism for adjusting the vertical angle of a tilt rotor type aircraft as the conventional invention is quite complicated, and entails poor flight stability due to high difficulty in flight control during the vertical angle adjustment. As compared to the above configuration, the vertical take-off and landing aircraft using a hybrid propulsion system and its control method according to an embodiment of the present invention may perform stable transition flight while slowly increasing thrust through propeller pitch control.

In addition, in a state where battery charging is impossible with surplus engine power during cruise flight due to engine failure and continuous cruise flight is also impossible, pure electric operation is performed to the nearest open area with remaining battery capacity. Then, for emergency vertical landing, a descent flight and then vertical landing method after stopping flight above a target landing site may be very dangerous due to insufficient battery, therefore, a combination of Short Takeoff and Landing (STOL) and Vertical Takeoff and Landing (VTOL) modes can be a way to land stably even in disturbances such as wind gusts possibly occurring during vertical landing/

### BRIEF DESCRIPTION OF DRAWINGS

FIG. 1 illustrates a system diagram of a vertical take-off and landing aircraft using a hybrid propulsion system according to an embodiment of the present invention.

FIGS. 2 and 3 illustrate an example of the vertical take-off and landing aircraft using a hybrid propulsion system according to an embodiment of the present invention.

FIGS. 4 and 5 illustrate another example of the vertical take-off and landing aircraft using a hybrid propulsion system according to an embodiment of the present invention.

FIGS. 6 and 7 illustrate another example of the vertical take-off and landing aircraft using a hybrid propulsion system according to an embodiment of the present invention.

FIG. 8 illustrates a control method of the vertical take-off and landing aircraft using a hybrid propulsion system according to an embodiment of the present invention, as an example of a flight path viewed from the side, and also an example in which a vertical take-off and landing aircraft repeatedly ascends and descends.

FIG. 9 illustrates a control method of the vertical take-off and landing aircraft using a hybrid propulsion system according to an embodiment of the present invention, which is an example of a flight path viewed from above, and also an example of operating a vertical take-off and landing aircraft in a zigzag manner.

FIG. 10 illustrates a control method of the vertical take-off and landing aircraft using a hybrid propulsion system according to an embodiment of the present invention, as an example of a flight path viewed from above, and also an example in which a vertical take-off and landing aircraft turns around a specific target.

FIG. 11 illustrates a control method of the vertical take-off and landing aircraft using a hybrid propulsion system according to an embodiment of the present invention, which is an example showing a process of safely landing step by step when normal vertical landing is impossible and emergency landing is required with minimum remaining battery power, and also an example applicable to any vertical take-off and landing aircraft.

### BEST MODE OF PREFERRED EMBODIMENTS OF INVENTION

Advantages and features of the present invention, as well as methods of achieving the same will become clear with reference to the detailed description of the following embodiments taken in conjunction with the accompanying drawings.

Hereinafter, embodiments of the present invention will be described in detail with reference to the accompanying drawings. The embodiments described below are shown by way of example to aid understanding of the present invention, and it should be understood that the present invention may be variously modified and practiced differently from the embodiments described herein. However, when it is determined that a detailed description of known functions or components related to the present invention may unnecessarily obscure the gist of the present invention, the detailed description and specific illustration thereof will be omitted. In addition, the accompanying drawings may not be drawn to an actual scale, but the sizes of some components may be exaggerated in order to aid understanding of the present invention.

Meanwhile, terms such as first and second may be used to describe various components, but the components should not be limited by the terms. These terms are only used for the purpose of distinguishing one component from another. For example, a first element may be termed a second element, and similarly, a second element may be termed a first element, without departing from the scope of the present invention.

On the other hand, terms to be described later are terms set in consideration of functions in the present invention, which may vary according to the intention or custom of the producer, therefore, the definitions should be made based on the contents throughout this specification. Like reference numbers designate like elements throughout the specification.

[Description of Reference Numerals]

| | |
|---|---|
| 1: Flight vehicle (that is, aircraft) | 2: Fuselage |
| 4: Fixed wing | |
| 10: Engine | 12: Fuel injection controller |
| 14: Fuel system | 16: Clutch device |
| 20: Generator (ISGM) | 30, 40: First and second power |
| | management units |
| 60: Battery management system | |
| 62: LIPO Battery Package | |
| 63, 64, 65: 1st, 2nd, 3rd power bus | |
| 66, 67, 68: 1st, 2nd, 3rd current | |
| stabilizer (DC-DC Converter) | |
| 70: Electronic speed controller | 80: Motor (IMG) |
| 82: Lift propeller | 81: Thrust propeller |
| 90: Control unit | |
| 100: Thrust system | 110: Lift system |

### DETAILED DESCRIPTION OF PREFERRED EMBODIMENTS OF INVENTION

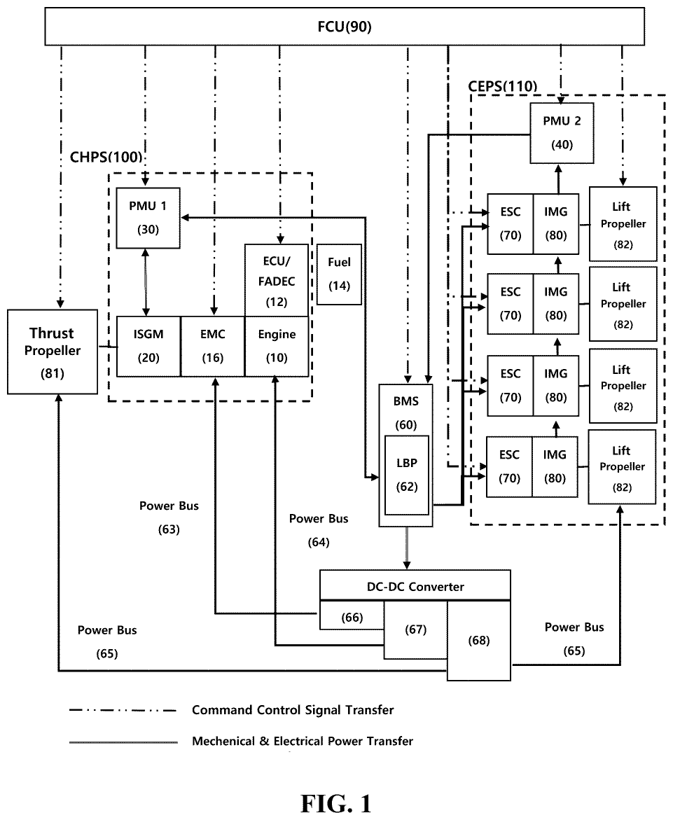

Hereinafter, a vertical take-off and landing aircraft using a hybrid propulsion system according to an embodiment of the present invention and a control method thereof will be described with reference to FIGS. 1 to 3. FIG. 1 is a view for explaining a pitch control propeller mounting form in the vertical take-off and landing aircraft using a hybrid propulsion system according to an embodiment of the present invention.

The vertical take-off and landing aircraft using a hybrid propulsion system according to an embodiment of the present invention may comprise: an aircraft 1; a battery management system 60; a thrust propeller 81; a lift propeller 82; a control unit 90; a thrust system 100 (Compound Hybrid Propulsion System for Cruising); and a lift system (110: Compound Electric Propulsion System for VTOL).

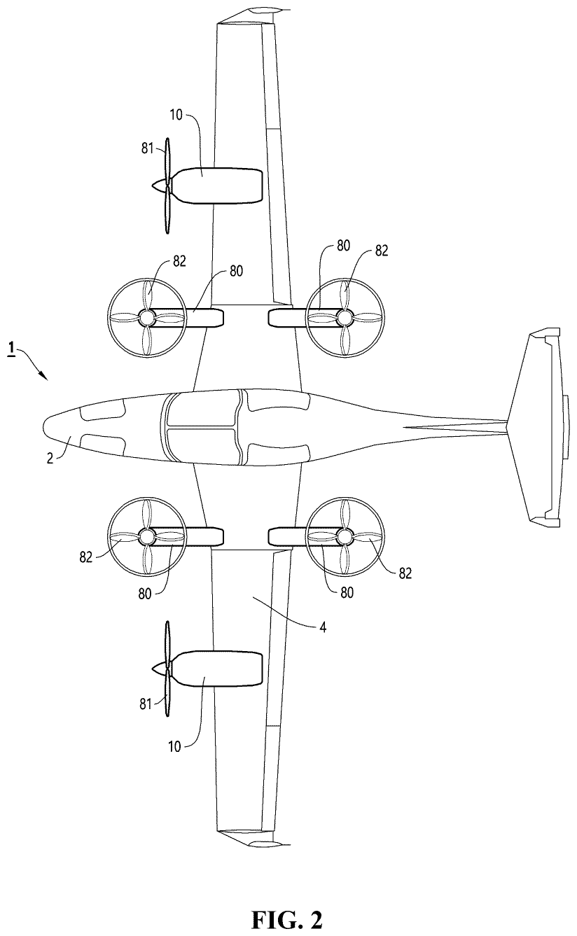

As shown in FIGS. 2 to 7, the aircraft 1 may have a fixed wing 4 on a fuselage 2.

The thrust system 100 is a configuration for applying thrust to the aircraft 1, and may comprise an engine 10, a clutch device 16, a first generator 20, and a first power management unit 30.

The engine 10 may be installed on the aircraft 1, more particularly, may be installed on the fixed wing 4, and may produce power by burning fuel.

The engine 10 may be provided with a fuel injection controller 12, and the fuel system 14 may precisely inject fuel into the engine 10 according to the control of the fuel injection controller 12.

The engine 10 may be a reciprocate engine that can control output through the fuel injection controller 12, and the fuel injection controller 12 may be an electronic fuel injection unit wherein a fuel injection amount of the reciprocating engine can be controlled according to a control signal from the control unit 90.

Further, the engine 10 may be a turbo-shaft engine that may include a speed reducer, and the fuel injection controller 12 may be a full authority digital engine control unit wherein a fuel injection amount of the turbo-shaft engine may be controlled according to a control signal from the control unit 90.

The clutch device 16 may connect the engine 10 and the first generator 20 under the control of the control unit 90 and may transmit power or block power.

The first generator 20 (ISGM: Integrated starter generator motor) may be connected to the engine 10 and may be operated with engine output to generate electric power.

The first generator 20 may also function as a starter, thereby starting the engine 10 by supplying electricity to the first generator 20 when the engine 10 is started.

The first generator 20 may also function as a boosting motor so that, in addition to the power of the engine 10, electricity is supplied to the first generator 20 whereby the thrust propeller 81 may further increase the thrust within Moment of Inertia available by the clutch device 16.

The first power management unit 30 (PMU: Power management unit) may manage the electric power, more specifically, manage the generated electric power, remaining electric power, battery charging power, etc., and start the first generator. When functioning as a motor or boosting motor, it manages to supply the required electric power from the battery pack 62.

The electric power produced by the first generator 20 may be managed by the first power management unit 30, for example, can be distributed to electronic components requiring power. After monitoring whether excessive electric power is produced, if the excessive electric power is produced, it can be controlled that the output of the engine 10 is reduced through the control unit 90 and the engine controller.

The battery management system 60 may comprise a battery pack 62, and power supplied from the first power management unit 30 may be charged in the battery pack 62.

The lift system 110 is a configuration for applying lift to the aircraft 1, and may comprise a second power management unit 40, an electronic speed controller 70, and a second generator 80.

The second power management unit 40 may charge the battery pack 62 of the battery management system 60 with electrical energy produced by the second generator 80 under the control of the control unit 90 and, when the lift propeller 82 includes a pitch controller and thus can adjust an angle of attack, the control unit 90 may control power generation efficiency to the maximum condition.

The second generator 80 may be installed on the fixed wing 4 or the fuselage 2, receive electricity from the battery management system 60, and may be operated to produce the required lift using individually connected electronic speed controllers 70 controlled by the control unit 90.

The second generator 80 may have both an electric power generation function and an electric motor function, thereby working as the electric motor when supplied with electrical energy, and may generate electricity when a rotational force of the lift propeller 82 is inputted.

The lift propeller 82 may be operated by the second generator 80. On the other hand, the lift propeller 82 may be installed in a vertical direction, and may also be installed to be inclined at an appropriate inclination according to the flight purpose of the aircraft 1.

The thrust propeller 81 may be operated by the engine 10.

On the other hand, the thrust propeller 81 may be equipped with a pitch controller, and the angle of attack of the thrust propeller 81 may be adjusted with the pitch controller.

The control unit 90 may control the fuel injection controller 12, the first and second power management units 30 and 40, and the battery management system 60 of the engine 10.

In the vertical take-off and landing aircraft using a hybrid propulsion system according to an embodiment of the present invention, several second generators 80 may be installed, and each second generator 80 may be equipped with an electronic speed controller 70.

Each of the electronic speed controllers 70 may receive electric power directly from the battery pack 62 under the control of the battery management system 60, and each of the electronic speed controllers 70 may control the speed of each second generator 80 separately by the control unit 90 or according to a command of the control unit 90, so that the required lift is generated through the lift propeller 82, and, at the same time, an attitude of the aircraft 1 can be stabilized during vertical take-off and landing and transition flight.

The control unit 90 may be implemented by an engine controller, a master control unit, a flight control computer (FCC), or the like.

The engine controller may control the number of revolutions of the engine 10 and, more specifically, may control the output of the engine 10 by opening and closing a throttle server or controlling a fuel injection pump.

The master control unit may generally control the aircraft 1, and the control unit 90 and the flight controller may control the flight operation of the aircraft 1, for example, may be used to control the speed, pressure, communication, posture of the aircraft 1, etc.

The control unit 90 may control to provide power supply from the first generator 20, the first power management unit 30 and the battery management system 60 to the second generator 80 simultaneously, when the aircraft 1 vertically takes off and lands.

The vertical take-off and landing aircraft using a hybrid propulsion system according to the embodiment of the present invention configured as above may use the lift propeller 82 when the aircraft 1 vertically ascends or descends for take-off and landing, and may use electricity output from the engine 10, the first generator 20 and the first power management unit 30 simultaneously in order to operate the thrust propeller 81, thereby reducing the capacity of the battery.

Accordingly, the vertical take-off and landing aircraft using a hybrid propulsion system according to the embodiment of the present invention can reduce the weight of the battery and further reduce the weight of the aircraft by the amount of the battery.

Further, the aircraft 1 may produce voltage required for the entire system through a current stabilizer (including a DC-DC converter function) in the battery management system 60, and also power buses 63, 64 and 65 may be configured to stably supply the voltage so as to provide required voltage to the system. The power buses 63, 64 and 65 are connected to different instrument panels, engine auxiliary devices, attitude controllers, convenience facilities, etc. in order to supply electricity to each component that consumes electricity. Further, second current stabilizers 66, 67 and 68 may be disposed between the battery management system 60 and the power buses 63, 64 and 65.

The first and second current stabilizers 66, 67 and 68 may serve to stabilize the current to a rated voltage.

The vertical take-off and landing aircraft using a hybrid propulsion system according to an embodiment of the present invention may use a lift propeller 82 during vertical take-off and landing. First, the engine 10 receives fuel from the fuel system 14 under the control of the control unit 90 and outputs power.

On the other hand, the pitch controller may adjust the angle of attack of the thrust propeller 81 even when the thrust propeller 81 is operated in connection with the engine 10, so that the wings of the thrust propeller 81 remain parallel to the travel direction of the aircraft. In other words, the angle of attack is made close to 90 degrees, whereby the power loss generated by the engine 10 can be reduced even when the thrust propeller 81 is operated.

The control unit 90 may control the pitch controller so that the thrust of the thrust propeller 81 does not affect the flight of the aircraft 1 at all when the aircraft 1 takes off and lands vertically. In more detail, the angle of attack of the thrust propeller 81 may be controlled to approach 0 degrees, whereby the thrust of the thrust propeller 81 becomes a “O” value and may not affect the flight of the aircraft 1 at all. Thereafter, the angle of attack of the thrust propeller 81 may be adjusted to have a positive value so as to obtain gradual thrust. Since the angle of attack of the thrust propeller 81 is close to “0”, even if the thrust propeller 81 rotates at the maximum output of the engine, no thrust is generated and the maximum amount of power generated by the engine may be used for electric power generation. In addition, with regard to ensuring flight stability and gradual thrust, adjusting the angle of attack of the thrust propeller 81 to have a positive value around 0 degree is more preferable than decreasing the value around 90 degree.

When the aircraft takes off and lands vertically, if there is no need to use the engine power or the engine 10 is operated in an idling state due to noise problems, it may be selected that the clutch device 16 is powered off to operate the thrust propeller 81 even in a stopped state.

On the other hand, the vertical take-off and landing aircraft using a hybrid propulsion system according to an embodiment of the present invention may use the thrust propeller 81 during transition flight or cruise flight.

With regard to the vertical take-off and landing aircraft using a hybrid propulsion system according to an embodiment of the present invention, desired thrust may be regulated by adjusting the angle of attack of the thrust propeller 81 at a transition flight altitude during transition flight.

Similarly, the vertical take-off and landing aircraft using a hybrid propulsion system according to an embodiment of the present invention may generate the required thrust by adjusting the angle of attack of the thrust propeller 81 during cruise flight.

More specifically, the vertical take-off and landing aircraft using the hybrid propulsion system according to the embodiment of the present invention may set the angle of attack of the thrust propeller 81 to 80 to 90 degrees or 0 degree during vertical take-off or transition flight between landing and cruise flight. In this regard, the angle of attack of the thrust propeller 81 may be slowly adjusted to around 25 degrees in a state of 80 to 90 degrees or close to 0 degree, thereby gradually obtaining thrust. Through this, the aircraft according to the present invention may gradually and safely enter the cruise flight from the transition flight, and can drastically reduce the problem that the flight stability of the conventional tilt-rotor type aircraft is reduced during the transition flight process. Furthermore, in the case of adjusting the thrust through pitch control as described above, when the power connection between the engine and the thrust propeller 81 is controlled through the clutch device, it is possible to avoid wear or the like of the clutch device 16 occurring since the clutch device is excessively used to adjust a rotational speed of the thrust propeller 81.

Further, the vertical take-off and landing aircraft using a hybrid propulsion system according to an embodiment of the present invention may obtain thrust reversal in the opposite direction by adjusting the angle of attack of the thrust propeller 81 to have a negative value. Through this, the vertical take-off and landing aircraft using the hybrid propulsion system according to the embodiment of the present invention may stably perform vertical take-off and landing by actively opposing the tailwind blowing forward from the rear of the aircraft during vertical take-off and landing.

Further, the vertical take-off and landing aircraft using a hybrid propulsion system according to an embodiment of the present invention may control pitch for each of the plurality of thrust propellers 81. Through this, in a vertical take-off and hovering state, the pitch value of the thrust propeller 81 may be adjusted differently, or the rotational speed may be adjusted differently to stop rotation in the air and change the direction of travel.

As such, the vertical take-off and landing aircraft using a hybrid propulsion system according to the embodiment of the present invention may actively adjust the angle of attack of each thrust propeller 81 to have a negative value or a positive value at 0 degree, so as to stably implement vertical take-off and landing and also improve flight stability during a process of vertical take-off to transition flight and a process of transition flight to vertical landing. Through this, it is possible to prevent motion sickness or the like of passengers inside the aircraft. The above effects are illustrative examples, and it is obvious that the effects of the present invention are not limited thereto.

Further, a wind direction or air volume sensor (not shown) may be provided at a predetermined position of the fixed wing 4 of the vertical take-off and landing aircraft according to the present invention. Preferably, the wind direction or air volume sensor is installed at the end of the fixed wing 4, therefore, it is detectable how much wind is blowing from which side with respect to the aircraft. Through this, the angle of attack of each thrust propeller 81 may be actively adjusted during vertical take-off and landing, thereby achieving stable vertical take-off and landing.

Assuming that a boost ratio is 10 when the aircraft 1 is in flight, the thrust required for cruising may be 1/10 of that at vertical ascent or vertical descent, and may be approximately ⅕ of that during acceleration or dash flight.

That is, although a lot of energy is required when the aircraft 1 vertically ascends or descends, energy consumption may be relatively small during cruise flight, whereby the remaining energy may be generated. The remaining energy may be electrical energy, and the remaining power may be charged in the battery pack 62.

The control unit 90 may improve the thrust of the thrust propeller 81 when the aircraft 1 is in cruise flight or transition flight, and may control such that the surplus electric power generated by the first generator 20 is charged in the battery pack 62 of the battery management system 60. As the battery pack 62 is charged, a flight time of the aircraft 1 may be further increased.

On the other hand, the vertical take-off and landing aircraft using a hybrid propulsion system according to an embodiment of the present invention may sum the output of the engine 10 and the output of the first generator 20 during transition flight, and use all of the output through the thrust propeller 81, wherein a ratio of the electrical energy provided to the thrust propeller 81 to the mechanical energy provided to the thrust propeller 81 according to the flight type of the aircraft 1 may further be controlled within the limit of allowable inertia moment of the clutch device 16 by the control unit 90.

With regard to the vertical take-off and landing aircraft using a hybrid propulsion system according to an embodiment of the present invention, when the aircraft 1 takes off and lands vertically, operating the clutch device 16 may block power transmission from the engine 10 to the thrust propeller 81, thereby reducing power loss.

Further, all of the mechanical energy produced by the engine 10 may be provided to the first generator 20 to increase electricity production, thereby enabling the first generator 20 to supply power stably with a large capacity. Furthermore, since the thrust propeller 81 acts well owing to the stable operation of the first generator 20, the vertical ascent or vertical descent of the aircraft 1 may be more smoothly implemented.

On the other hand, during transition flight, the clutch device 16 is operated at the transition flight altitude to connect the engine 10 and the thrust propeller 81 so that the thrust propeller 81 can improve thrust. The control unit 90 may control the fuel injection controller 12 to adjust the engine output of the engine 10, while the clutch device 16 may transmit the power of the engine 10 to the thrust propeller 81 during cruise flight.

FIG. 1 illustrates a system diagram of the vertical take-off and landing aircraft using a hybrid propulsion system according to an embodiment of the present invention. Descriptions overlapping with the previously described technical descriptions will be omitted.

The engine 10 may be equipped with a pitch controller or clutch device 16.

The angle of attack of the thrust propeller 81 may be adjusted by the pitch controller, while the clutch device 16 may cut off or connect power transmitted from the engine 10 to the thrust propeller 81.

The vertical take-off and landing aircraft using a hybrid propulsion system according to an embodiment of the present invention may have both a clutch device 16 and a pitch controller 100.

The first generator 20 may further include a sensor, and the sensor may be connected to the first power management unit 30. The sensor may monitor the first generator 20 and, on the basis of the detected first detection value, the control unit 90 may determine whether current power production is appropriate or not.

When power generation is insufficient, the control unit 90 may control the fuel injection controller 12 to increase an amount of fuel injection, thereby increasing the number of engine revolutions.

Conversely, if electric power is excessively produced, the control unit 90 may control the fuel injection controller 12 to reduce the amount of fuel injection, thereby decreasing the number of revolutions of the engine.

In the vertical take-off and landing aircraft using a hybrid propulsion system according to an embodiment of the present invention, several second generators 80 may be installed, and each second generator 80 may be equipped with an electronic speed controller 70. Each electronic speed controller 70 may individually control the speed of each second generator 80 according to the command of the control unit 90, thereby stabilizing the attitude of the aircraft 1.

On the other hand, the battery pack 62 may be configured of batteries in parallel and, when managed by the battery management system 60, may have a charging rate faster than 2 C-Rate and a discharging rate faster than maximum 60 C-Rate, thereby responding more effectively to emergencies.

Further, the battery pack 62 of the battery management system 60 may supply electricity to each electronic speed controller 70 at a level around a fast discharging rate of 30 C-Rate.

Meanwhile, each electronic speed controller 70 may comprise a separate power bus and is connected to each power line in order to receive electricity.

The power buses 63, 64 and 65 may supply electricity to various electronic devices in order to operate the same.

Various electronic devices may work while receiving a command from the control unit 90.

Various electronic devices may be necessary for the flight of the aircraft 1, and may operate, for example, a drive wing or a tail wing. Electricity from the battery management system 60 may be connected to the power buses 63, 64, and 65.

Meanwhile, a load value may vary according to electricity consumption in each of the electronic speed controllers 70. When the load value is detected, the load value may be provided to the second power management unit 40 or the control unit 90.

When the load value increases, it may be determined that power consumption increases, and in this case, the control unit 90 may control the engine output of the engine 10 to increase. Conversely, when the load value decreases, it is determined that power consumption is reduced, and the engine output of the engine 10 may be controlled to decrease.

In other words, the vertical take-off and landing aircraft using a hybrid propulsion system according to an embodiment of the present invention may detect in real time the electric power consumed to operate the thrust propeller 81 and control the engine output of the engine 10 to thus produce optimal electric power.

Hereinafter, various embodiments of the vertical take-off and landing aircraft using a hybrid propulsion system according to an embodiment of the present invention will be described with reference to FIGS. 2 to 7.

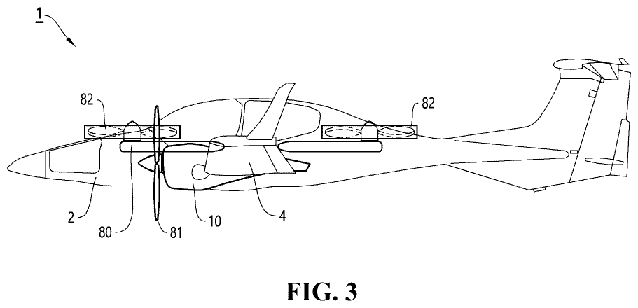

FIGS. 2 and 3 are views illustrating an example of the vertical take-off and landing aircraft using a hybrid propulsion system according to an embodiment of the present invention. FIG. 2 is a plan view of the aircraft 1 while FIG. 3 is a side view of the aircraft 1.

As shown in FIGS. 2 and 3, fixed blades 4 are provided on both sides of the front of a fuselage 2, and second generators 80 are installed in a substantially vertical direction in front and rear of both fixed blades 4. Each second generator 80 may be equipped with a lift propeller 82, and the engines 10 may be installed horizontally on both fixed blades 4, wherein each engine 10 may be provided with a thrust propeller 81.

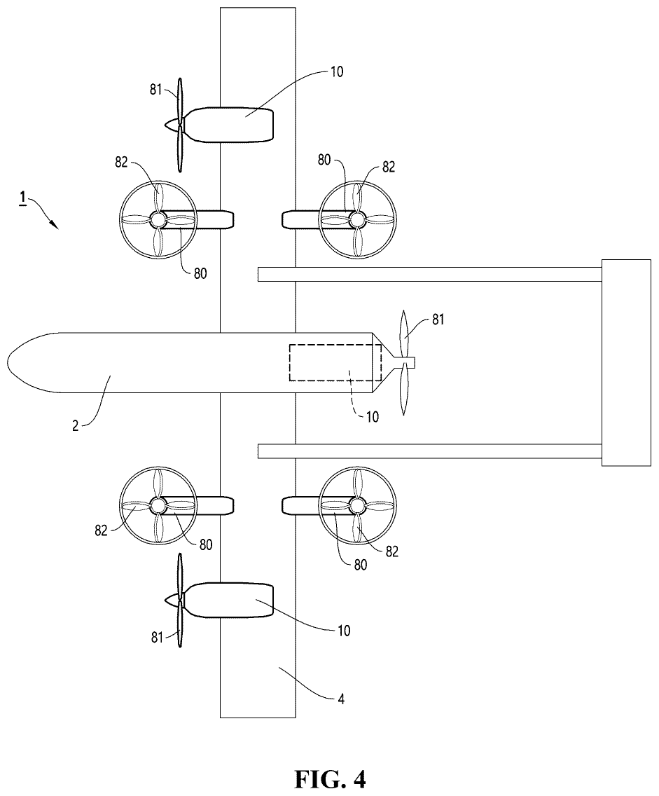

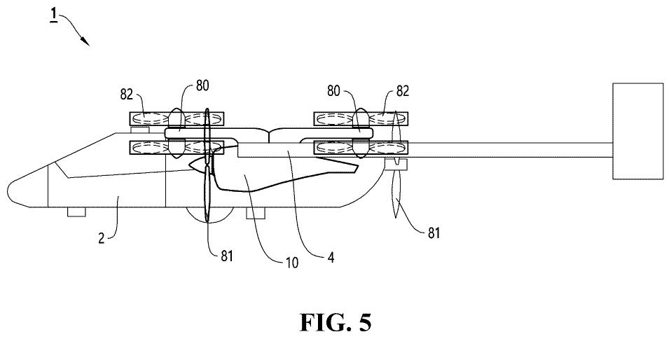

FIGS. 4 and 5 are views illustrating another example of the vertical take-off and landing aircraft using a hybrid propulsion system according to an embodiment of the present invention. FIG. 4 is a plan view of the aircraft 1 while FIG. 5 is a side view of the aircraft 1.

As shown in FIGS. 4 and 5, fixed blades 4 are provided on both sides of a fuselage 2, and second generators 80 are installed in a substantially vertical direction in front and rear of both fixed blades 4. Each second generator 80 may be equipped with a lift propeller 82, and the engines 10 may be installed horizontally on both fixed blades 4, wherein each engine 10 may be provided with a thrust propeller 81. In addition, the engine 10 and the thrust propeller 81 may be further provided at the rear of the aircraft 1.

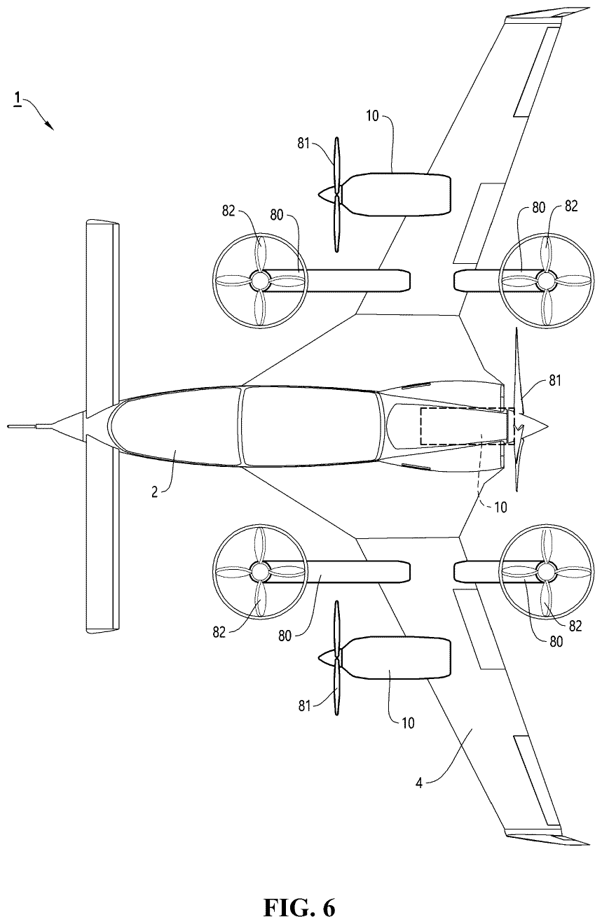

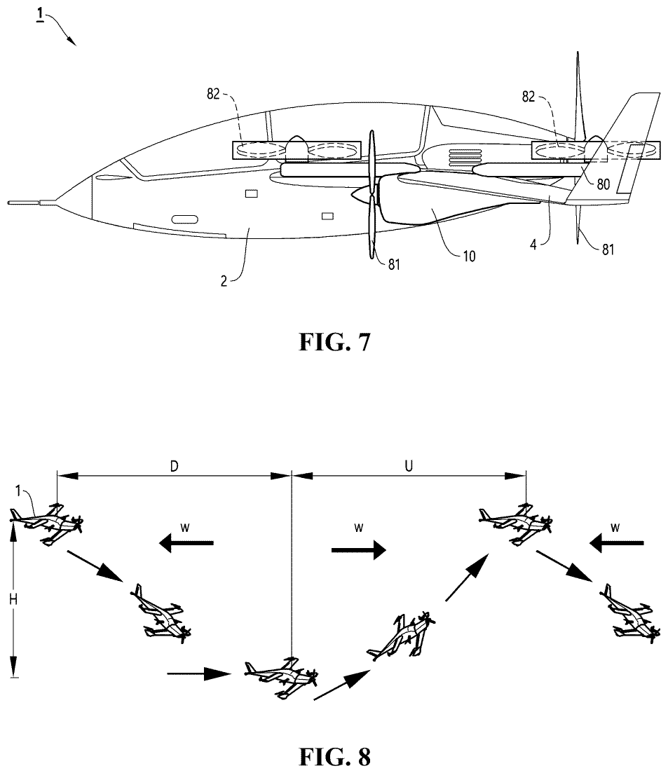

FIGS. 6 and 7 are views illustrating another example of the vertical take-off and landing aircraft using a hybrid propulsion system according to an embodiment of the present invention. FIG. 6 is a plan view of the aircraft 1 while FIG. 7 is a side view of the aircraft 1.

As shown in FIGS. 6 and 7, fixed blades 4 are provided on both sides of the rear of a fuselage 2, and second generators 80 are installed in a substantially vertical direction in front and rear of both fixed blades 4. Each second generator 80 may be equipped with a lift propeller 82, and the engines 10 may be installed horizontally on both fixed blades 4, wherein each engine 10 may be provided with a thrust propeller 81.

The vertical take-off and landing aircraft using a hybrid propulsion system according to an embodiment of the present invention, as described with reference to FIGS. 2 to 7, may be applicable even if the structure of the vehicle 1 is diverse.

With reference to FIGS. 8 to 10, the vertical take-off and landing aircraft using a hybrid propulsion system according to an embodiment of the present invention and a control method thereof will be described in detail.

As shown in the descending section (D) in FIG. 8, the aircraft 1 may descend or fly against the wind. In the descending section D, the thrust propeller 81 rotates due to the headwind, and the first generator 20 may generate electricity by the rotational force of the thrust propeller 81 to produce electric power.

Further, when the aircraft 1 descends or flies against the wind, the lift propeller 82 may rotate owing to the wind, and the second generator 80 may generate electricity by the rotational force of the lift propeller 82 to produce electric power.

The battery management system 60 may be charged with electricity generated from the first and second generators 20 and 80.

That is, in the descending section D of the aircraft 1 in FIG. 8, the control unit 90 may control the first and second generators 20 and 80 to generate electric power.

Further, as shown in the ascending section U in FIG. 8, the aircraft 1 may fly upward or fly with a tailwind.

Further, as shown in the elevation section H in FIG. 8, the aircraft 1 may repeat a specific elevation section H, the descending section D and the ascending section U. A first horizontal movement distance of the ascending section U may be shorter than a second horizontal movement distance of the descending section D. The reason why the first horizontal movement distance is shorter than the second horizontal movement distance may be that flight is implemented using thrust and lift in the ascending section U.

The control unit 90 may control the first and second generators 20 and 80 to work as electric motors when the aircraft 1 flies upward or flies with a tailwind.

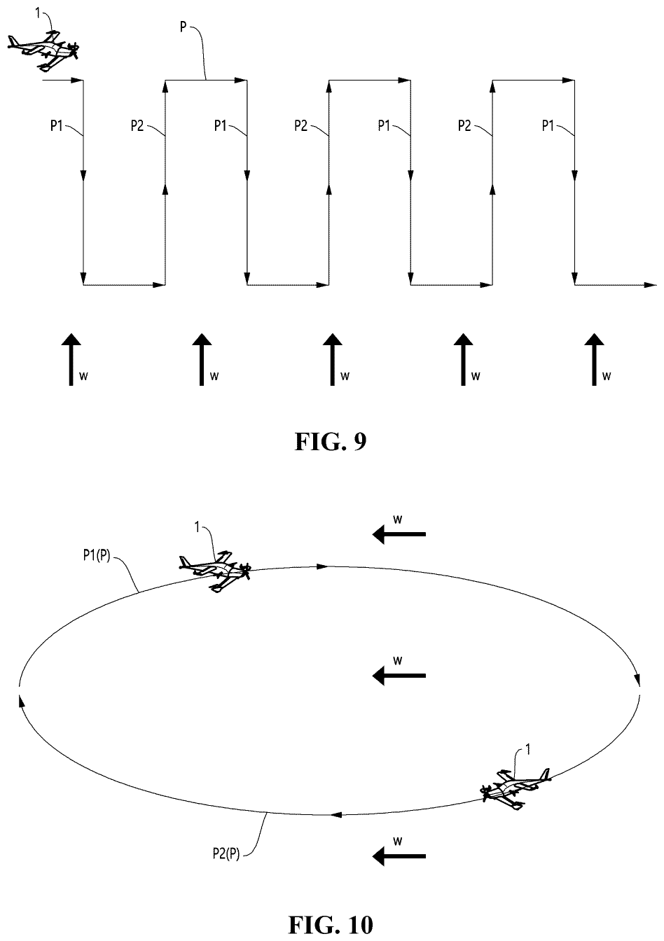

FIG. 9 illustrates an example in which the wind (w) is blowing in a specific direction when the flight path P varies in a zigzag manner in a specific area.

As shown in FIG. 9, when the flight path P varies in a zigzag pattern, there may be a first path P1 facing the wind in a certain section and a second path P2 receiving the tail wind in another section.

When the aircraft 1 receives a headwind along the first path P1, power generation may be attempted in the first and second generators 20 and 80 while descending. Conversely, when the air vehicle 1 receives the tailwind along the second path P2, the first and second generators 20 and 80 may work as generators to form thrust and lift, respectively.

FIG. 10 illustrates an example in which the aircraft 1 has a flight path P, wherein the aircraft 1 rotates round and round with a specific area at the center, and the wind (w) is blowing in a specific direction.

Accordingly, when the aircraft 1 performs a turning flight in a specific area, there may be a first path P1 receiving a headwind in a certain section, and a second path P2 receiving a tailwind in some other section.

When the aircraft 1 receives a headwind along the first path P1, it can attempt power generation in the first and second generators 20 and 80 while descending. Conversely, when the aircraft 1 receives a tailwind along the second path P2, the first and second generators 20 and 80 may work as electric motors to form thrust and lift, respectively.

Therefore, in the vertical take-off and landing aircraft using a hybrid propulsion system and its control method according to an embodiment of the present invention, the first and second generators 20 and 80 may generate electricity when the aircraft faces headwind or descends so as to charge the battery pack 62, thereby achieving effects of increasing the flight time.

The control unit 90 may control the clutch device 16 to cut off power so that the power is not transmitted from the engine 10 to the thrust propeller 81 when the first generator 20 acts to generate electric power. That is, when a rotor of the first generator 20 is about to rotate, a power generation ability of the first generator 20 may be enhanced by eliminating resistance capable of acting from the engine 10.

A control method of the vertical take-off and landing aircraft using a hybrid propulsion system according to an embodiment of the present invention will be described step by step.

The first step (S1) is a flight stage in that the thrust propeller 81 is operated using the power of the engine 10 or the electricity of the battery pack 62, and the lift propeller 82 is operated using the electricity of the battery pack 62. In the first step (S1), the aircraft 1 may be in a normal flight state such as vertical take-off and landing flight, transition flight, and cruise flight.

The second step (S2) is a stage in that the first generator 20 is operated to generate electric power by the rotational force of the thrust propeller 81 and the second generator 80 is operated to generate electric power by the rotational force of the lift propeller 82 when the aircraft 1 flies in the descending section D or flies with a headwind.

The third step (S3) is a stage in that the battery pack 62 is charged with the electric power generated by the first and second generators 20 and 80 in the second step (S2).

The fourth step (S4) is a flight stage in that the thrust propeller 81 is operated using the power of the engine 10 or the electricity of the battery pack 62 and the lift propeller 82 is operated using the electricity of the battery pack 62 when the aircraft 1 undergoes the tailwind or flies the ascending section U.

On the other hand, in the second step (S2), the power may be cut off by operating the clutch device 16 so that the power is not transmitted from the engine 10 to the thrust propeller 81. That is, as described above, power connection from the engine 10 to the first generator 20 is physically cut off so that the rotor may be in a no-load state, whereby the first generator 20 rotates more easily and may contribute to increasing a generation capacity.

On the other hand, the vertical take-off and landing aircraft using a hybrid propulsion system according to an embodiment of the present invention may take off only electrically while turning off the engine 10 due to a noise problem.

More specifically, in a state where the power transmission of the clutch device 16 is cut off, vertical take-off can be achieved by the operation of the lift propeller 82 up to an appropriate altitude that can overcome the noise problem, and the vertical take-off, transition flight and cruise flight can be implemented in pure electric mode.

Thereafter, when the aircraft 1 reaches an altitude at which the noise problem can be overcome, the clutch device 16 is operated by power connection, the first generator 20 is operated to start the engine 10, and then cruise flight can be initiated using the engine power.

Then, as described above, the first generator 20 may be operated in a no-load state when flying in a headwind or descending section D. Further, if additional output is further required in addition to the engine output, the first generator 20 may work as an electric motor to increase output.

Meanwhile, engine starting may be performed as possible after vertical take-off in consideration of flight safety, when a stable cruise flight is conducted before or after transition flight.

On the other hand, the vertical take-off and landing aircraft using a hybrid propulsion system according to an embodiment of the present invention may take off in a hybrid manner as the engine 10 turned on.

More specifically, after the engine 10 is started using the first generator 20 in a state in which the clutch device 16 is power-connected, the engine 10 may be operated in an idle state.

In the case of vertical take-off with the clutch device 16 connected to power, when there is a headwind, a direction of the aircraft 1 may be selected while being directed toward the headwind, and the engine output may be controlled to a level capable of overcoming the headwind.

Thereafter, when the vertical take-off and landing aircraft using a hybrid propulsion system according to an embodiment of the present invention performs transition flight, the first generator 20 works as an electric motor in addition to the engine thrust, so as to add and use the output within the allowable inertia moment of the clutch device 16.

On the other hand, in the case of vertical take-off with the clutch device 16 powered off, the vertical take-off may be performed purely electrically until reaching an appropriate altitude for the transition flight. Thereafter, thrust can be implemented with engine output by starting transition flight or connecting the clutch device 16 in a hovering state.

In addition, a control method when the vertical take-off and landing aircraft using a hybrid propulsion system according to an embodiment of the present invention is under normal transition flight after vertical take-off will be described.

### <How to Secure Thrust in the Direction of Cruise Flight>

In the case of vertical take-off as the engine 10 turned on, the blocked clutch device 16 is connected, engine output is used and, in order to reduce the transition flight time, the first generator 20 may work as an electric motor to use the output additionally.

When transition flight is required while the engine 10 is turned off and the clutch device 16 is powered off due to a noise problem, the thrust propeller 81 is operated by operating the first generator as an electric motor, so as to perform flight.

### <How to Secure Lift>

Until the aircraft 1 exceeds the stall speed, the lift propeller 82 is operated to generate lift, and the lift generated from the fixed wing 4 according to the forward speed in the cruise flight direction may be controlled through the control unit 90.

Thereafter, in a state where the flight speed of the aircraft 1 exceeds a suitable level than the stall speed, it can fly using only the lift generated from the fixed wing 4.

### <Posture Control Method>

The second generator 80 works as an electric motor, and a difference in thrust between the plurality of lifting propellers 82 occurs or, at the same time, ailerons and flaps mounted on the fixed wings 4 of the fixed-wing type aircraft as well as the elevator an rudder mounted on the wail wing may be automatically controlled through the control unit 90 or a flight control computer.

Further, the control method when the vertical take-off and landing aircraft using a hybrid propulsion system according to an embodiment of the present invention is under transition flight in order to make a vertical landing during cruise flight will be described in detail.

### <How to Secure Thrust in the Direction of Cruise Flight>

When the engine 10 is turned on (On) and the clutch device 16 is power-connected, only the engine thrust is used. Further, for vertical landing, the engine 10 is turned off (Off) in the hovering position and the clutch device 16 may be subject to vertical landing conditions for power off decision.

When there should be no noise problem in the vertical landing condition, the engine 10 is turned off. When the clutch device 16 is powered off and the transition flight must be performed, the first generator 20 for cruise flight works as an electric motor and thrust is generated with the thrust propeller 81, thereby enabling cruise flight.

### <How to Secure Lift>

Before the aircraft 1 enters the stall speed, in consideration of reduction in lift generated from the fixed wing 4 according to the decrease of forward speed in the cruising direction, the second generator 80 works as an electric motor, vertical upward thrust is gradually increased using the lift propeller 82, and the second generator 80 may be automatically controlled through the control unit 90 or flight controller.

When the aircraft 1 hovers just before the vertical landing, the necessary lift may be secured only by the sum of the lift generated from the plurality of lift propellers 82.

### <Attitude Control Method>

The aircraft 1 operates the second generator 80 as an electric motor, and the thrust difference of the plurality of lifting propellers 82, the ailerons and flaps mounted on the fixed wing 4 of the fixed-wing type aircraft and the elevator and rudder mounted on the tail-wing may be automatically controlled using the control unit 90 or flight controller.

On the other hand, the vertical take-off and landing aircraft using a hybrid propulsion system and a control method thereof according to an embodiment of the present invention may operate a thrust propeller 81 using engine output and electrical energy to perform cruise flight, and such control method may be used when rapid acceleration or rapid ascent flight is required.

### <How to Make an Emergency Landing>

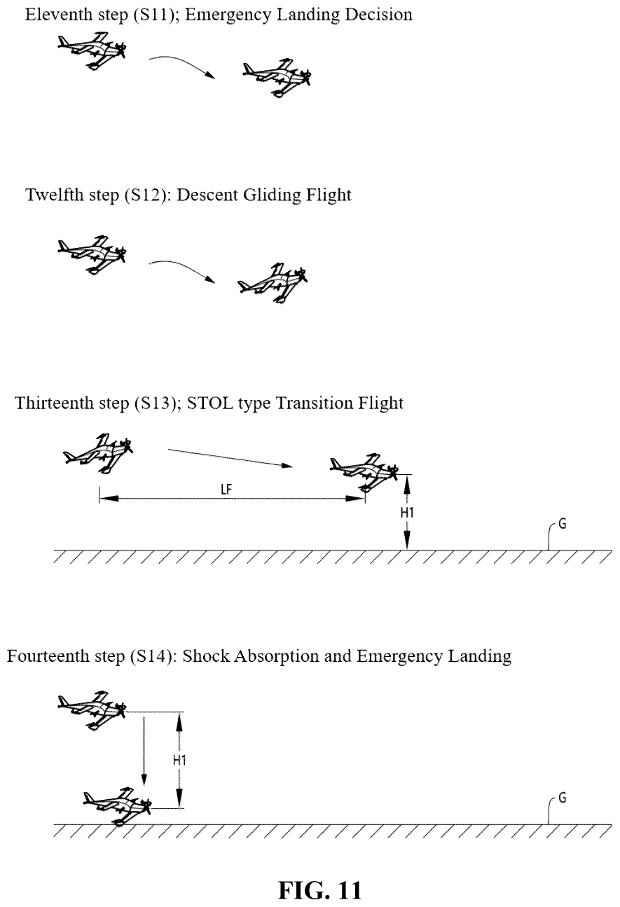

Referring to FIG. 11, an emergency landing method for the vertical take-off and landing aircraft using a hybrid propulsion system according to an embodiment of the present invention will be described.

If an emergency landing is required, regardless of the state of the engine 10, it is possible to select a candidate for emergency landing in a purely electrical manner and then fly in a gliding mode and, at the same time, to secure additional power required for emergency landing, thereby minimizing damage.

### Eleventh Step (S11)—Emergency Landing Decision:

Cases for attempting an emergency landing may include: when to fly and vertically land to a target landing site in pure electric manner are impossible due to an engine failure; when a pilot is unable to control due to health problems; it is recognized as a terrorist flight and it is necessary to make an emergency landing through remote control from the ground control center; or, in consideration of a plan to minimize ground damage, the emergency landing should be done in a safe zone.

As shown in the example of FIG. 11, Emergency Landing of the aircraft 1 determines the emergency landing.

### Twelfth Step (S12)—Descent Glide Flight:

Pure electric mode flight or descent gliding to near emergency landing destination is performed.

### Thirteenth Step (S13)—Short-Distance Landing (STOL) Type Transition Flight

The aircraft 1 utilizes flaps, which are high-lift devices mounted on the main wings, just before emergency landing to fly to a specific altitude (H1) at which Ground Effect can be expected in the short-distance landing (STOL) mode of a fixed-wing type aircraft. Symbol LF described in FIG. 11 is a flight distance for emergency landing.

When reaching a certain altitude (H1) at which ground effect can be expected, the lift propeller is used to fly horizontally at the minimum distance to overcome inertia.

### Fourteenth Step (S14)—Shock Absorption and Emergency Landing

Subsequently, this step may be configured such that: the aircraft 1 completes the transition flight phase in a method of checking the target landing site through a brief hovering at the same altitude; and then proceeds emergency landing while absorbing shock by maximizing the capacity of the remaining battery.

The decision on the emergency landing in step 11 (S11) may be made by: the pilot of the boarding aircraft or the remote pilot at the ground control center when the engine is out of order; the remote pilot at the ground control center when the pilot of the aircraft is unable to operate due to health problems; and authorized controllers at the air traffic control center in accordance with Aviation Act when a suspicious flight is done for terrorist purposes or outside the authorized flight area.

The decision on the emergency landing site may be automatically provided in a priority order by calculating the flight distance according to the amount of remaining battery and selecting the candidate site where it is determined that an emergency landing is possible on the pre-approved flight route. Further, the landing site may be selected by the pilot of the boarding aircraft or the remote pilot within a limited time. Further, if the limited selection time is exceeded, the nearest emergency landing site may be automatically selected.

The flight to the emergency landing site is a descent flight in a gliding mode, and the battery pack 62 may be charged by the power generation function of the first generator 20 during descent flight.

On the other hand, STOL (Short Take-off and Landing) is performed such that: a fixed wing 4 is equipped with flaps which are high-lift devices, and winglets which reduce induced drag, so that fly-past may be performed to a point close to a target point for emergency landing with ground effects in a fixed-wing mode; and using the remaining battery electricity for a very short time enables transition flight and hovering. Subsequently, it is possible to have emergency landing function in the vertical landing manner at an altitude of the span of the main wing within the ground effects.

On the other hand, in the case of the vertical landing, a descending speed for a normal vertical landing may be determined in consideration of the amount of electricity remaining in the battery, and the descending speed may be determined to enable maximum shock absorption.

In order to absorb the momentary shock at the landing on the ground, the lift propeller 82 may be operated efficiently in a short time by maximally utilizing the remaining power amount of the battery pack 62 and the high discharging rate, for example, around 30 C-Rate. Further, the second generator 80 may be automatically controlled through the control unit 90 and the speed controller 70.

Although the embodiments of the present invention have been described with reference to the accompanying drawings, those skilled in the art to which the present invention belongs would understand that the present invention can be implemented in other specific forms without changing the technical spirit or essential features of the invention.

Therefore, the embodiments described above should be understood as illustrative and not restrictive in all respects, and the scope of the present invention is indicated by the claims to be described later, and is derived from the meanings and scope of the claims and equivalent concepts thereof. All changes or modified forms should be construed as being included within the scope of the present invention.

### INDUSTRIAL APPLICABILITY

The vertical take-off and landing aircraft using a hybrid propulsion system and a control method thereof according to an embodiment of the present invention may be used to control flight such as vertical take-off and landing flight, transition flight and cruise flight.

1. A vertical take-off and landing aircraft using a hybrid propulsion system, comprising:
a thrust propeller generating thrust to the aircraft;
a lift propeller generating lift to the aircraft;
an engine installed on the aircraft to generate power by burning fuel;
a clutch device for transmitting the power of the engine to the thrust propeller;
a first generator that generates electric power with rotational force of the thrust propeller through rotation of the thrust propeller when the aircraft descends or flies against a headwind;
a second generator that generates electric power with rotational force of the lift propeller through rotation of the lift propeller when the aircraft descends or flies against the headwind;
a battery management system in which electricity generated from the first and second generators is charged; and
a control unit for controlling the first and second generators to work as electric motors when the aircraft flies upward or flies with a tailwind.

2. The vertical take-off and landing aircraft according to claim 1, wherein the control unit controls the clutch device to cut off power so that the power is not transmitted from the engine to the thrust propeller when the first generator is operated with the power of wind to generate electric power.

3. The vertical take-off and landing aircraft according to claim 1, wherein the control unit controls an angle of attack to decrease so that the thrust of the thrust propeller does not affect the flight of the aircraft at all when the aircraft takes off and lands vertically.

4. The vertical take-off and landing aircraft according to claim 1, wherein the control unit controls the thrust of the thrust propeller to increase when the aircraft is in cruise flight or transition flight, and the surplus electric power produced by the first generator to be charged in the battery pack of the battery management system.

5. The vertical take-off and landing aircraft according to claim 4, wherein the battery pack comprises batteries configured in parallel and, when managed by the battery management system, has a charging rate faster than 2 C-Rate and a discharging rate faster than maximum 60 C-Rate.

6. The vertical take-off and landing aircraft according to claim 1, wherein the first generator works as an electric motor that increases the thrust within an allowable inertia moment limit of the clutch in addition to the output of the engine, or works as a pure electric motor regardless of the engine.

7. The vertical take-off and landing aircraft according to claim 1, further comprising:
a first power management unit that manages the electric power by receiving a command from the control unit,
wherein the first power management unit manages the electric power produced by the first generator, distributes the electric power to electronic components that require the electric power, monitors whether excess electric power is produced and, if the excess electric power is produced, controls the engine output to be reduced through the control unit and the engine controller.

8. A control method of a vertical take-off and landing aircraft using a hybrid propulsion system, comprising:
a first step of operating a thrust propeller using power from an engine or electricity from a battery pack and operating a lift propeller using the electricity from the battery pack to fly the aircraft;
a second step of operating a first generator with rotational force of the thrust propeller to generate electric power while operating a second generator with rotational force of the lift propeller to generate electric power when the aircraft is flying in a headwind or descends;
a third step of charging the battery pack with the electric power generated by the first and second generators in the above second step; and
a fourth step of operating the thrust propeller using the power of the engine or the electricity of the battery pack while operating the lift propeller with the electricity of the battery pack when the aircraft meets tailwind or ascends.

9. The control method according to claim 8, wherein the power is cut off by operating the clutch device in order to prevent power transmission from the engine to the thrust propeller in the second step.

10. The control method according to claim 8, wherein an angle of attack is controlled to decrease such that the thrust of the thrust propeller does not influence on the flight of the aircraft when the aircraft takes off and lands vertically.

11. The control method according to claim 8, wherein the thrust of the thrust propeller is increased when the aircraft is in cruise flight or transition flight, while the surplus electric power generated in the first generator is charged in the battery pack of the battery management system.
